(19) United States
(12) Patent Application Publication
(10) Pub. No.: US 2017/0096041 A1
(43) Pub. Date: Apr. 6, 2017

(54) Active Vehicle Suspension System

(71) Applicant: Thomas-Dempsey Motors, Inc., Carson City, NV (US)

(72) Inventor: Robert H. Dempsey, Carson City, NV (US)

(21) Appl. No.: 15/287,640

(22) Filed: Oct. 6, 2016

Related U.S. Application Data
(60) Provisional application No. 62/238,011, filed on Oct. 6, 2015.

(51) Int. Cl. B60G 17/015; B60G 17/02; B60G 17/052; B60G 17/018; B60G 17/016; B60G 15/08; B60G 11/18; B60G 17/019

(52) U.S. Cl. CPC B60G 17/0152; B60G 11/183; B60G 17/025; B60G 17/01908; B60G 17/018; B60G 17/0162; B60G 17/0164; B60G 15/08; B60G 17/0528; B60G 2202/134; B60G 2200/22; B60G 2202/42; B60G 2202/30; B60G 2202/415

(57) ABSTRACT

A vehicle suspension system is disclosed. The vehicle suspension system can include a first spring having a first spring characteristic, a second spring having a second spring characteristic, and an actuator coupled to the first and second springs such that actuation of the actuator causes a change in the first and second spring characteristics. The change in the second spring characteristic can be inversely proportional to the change in the first spring characteristic to adjust vehicle handling.

### RELATED APPLICATION

This application claims the benefit of U.S. Provisional Patent Application No. 62/238,011 filed on Oct. 6, 2015, which is incorporated herein by reference in its entirety.

### BACKGROUND

Vehicles, such as cars and trucks, typically utilize dampened spring suspension systems to enhance ride comfort and vehicle performance. Typical springs utilized are mechanical springs (i.e., springs made of a resiliently flexible material such as metal) and/or pneumatic (i.e., gas or air) springs. Mechanical springs are often in a coil or leaf spring configuration. Gas springs are often configured as pneumatic cylinders, air bladders, or air bags. Some gas springs can be inflated or deflated (e.g., to increase or decrease pressure) to accommodate a given load and/or to adjust ride height.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic illustration of a vehicle in accordance with an example of the present disclosure.

FIG. 2 is a schematic illustration of a vehicle in accordance with another example of the present disclosure.

FIG. 3 is a schematic end view illustration of a vehicle suspension system in accordance with an example of the present disclosure.

FIG. 4 is a schematic top view illustration of a vehicle suspension system in accordance with another example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although the springs typically utilized in vehicle suspension systems are functional and have many advantages, spring characteristics are not often adjustable while a vehicle is in operation. Those springs that are adjustable during use are typically gas springs, which rely on the introduction of gas to or the removal of gas from the system in order to change the spring performance. This may provide an unacceptably slow response to a dynamic loading situation of the vehicle, such as cornering, acceleration, and/or braking. In addition, the continual need to provide pressurized gas may be energy inefficient, and/or costly. Thus, suspension system performance can be improved by eliminating a reliance on the addition or removal of gas in order to change spring characteristics.

Accordingly, a vehicle suspension system is disclosed that can dynamically vary spring characteristics while a vehicle is in operation. In one aspect, spring characteristics can be changed without the addition or removal of gas. As such, the system can be more efficient than one where gas is continually being added or removed. The vehicle suspension system can include a first spring having a first spring characteristic, a second spring having a second spring characteristic, and an actuator coupled to the first and second springs, whereby actuation of the actuator causes a change in the first and second spring characteristics. The change in the second spring characteristic can be inversely proportional to the change in the first spring characteristic to adjust vehicle handling.

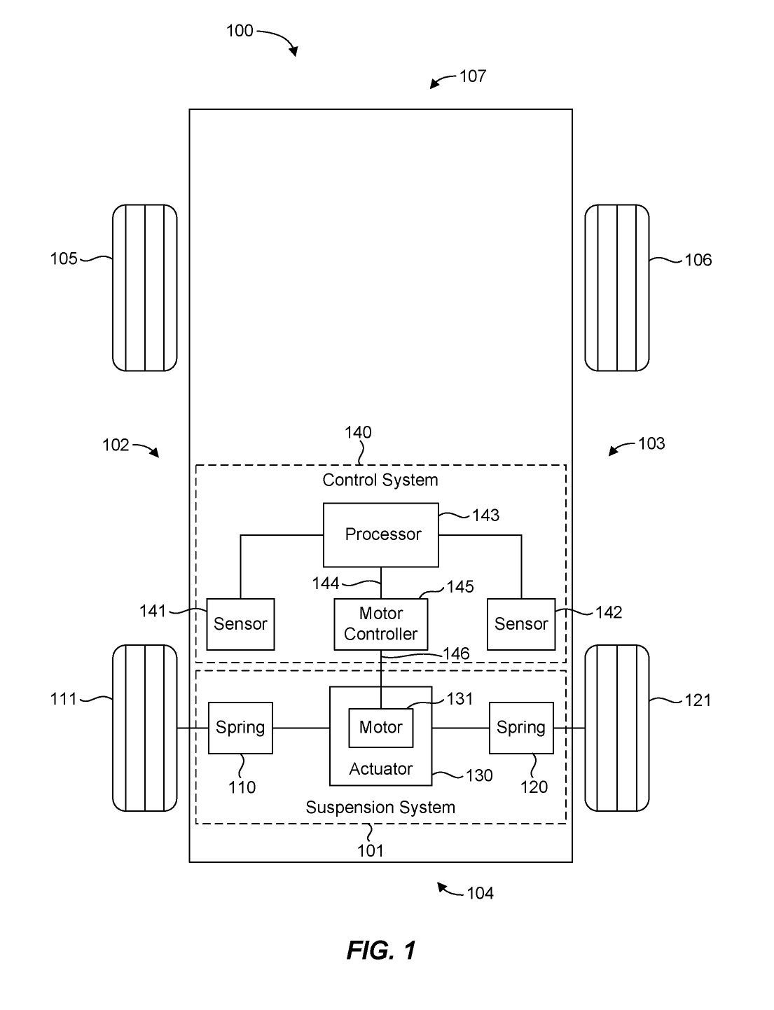

One example of a vehicle 100 is illustrated schematically in FIG. 1. The vehicle 100 can comprise a suspension system 101. In general, the suspension system 101 can include springs 110, 120 and an actuator 130 coupled to the springs 110, 120. The vehicle 100 can also comprise a suspension control system 140 that can include one or more sensors 141, 142 and can be configured to monitor vehicle dynamics and control the suspension system 101 to adjust vehicle handling in response to the vehicle dynamics.

The suspension system 101 can be coupled to any two or more wheels of the vehicle 100. For example, the suspension system 101 can be coupled to the wheels 111, 121 via the springs 110, 120, respectively. As illustrated in FIG. 1, the suspension system 101 is coupled to the wheels 111, 121, which are located on opposite sides 102, 103 (e.g., left/right or driver/passenger sides) at a rear end 104 of the vehicle 100. Alternatively, the suspension system 101 can be coupled to wheels 105, 106, which are located on opposite sides 102, 103 (e.g., left/right or driver/passenger sides) at a front end 107 of the vehicle 100. In some embodiments, the suspension system 101 can be coupled to two or more wheels 105, 111 on one side 102 of the vehicle 100, and to two or more wheels 106, 121 on the opposite side 103 of the vehicle 100. Thus, a suspension system as disclosed herein can be coupled to one or more wheels (e.g., front and/or rear wheels) on one side of a vehicle and to one or more wheels (e.g., front and/or rear wheels) on an opposite side of the vehicle. In one embodiment, the suspension system 101 can be coupled to the front wheel 105 and to the rear wheel 111 on the same side 102 of the vehicle 100. In another embodiment, the suspension system 101 can be coupled to the front wheel 106 and to the rear wheel 121 on the same side 103 of the vehicle 100. Thus, a suspension system as disclosed herein can be coupled to one or more wheels on the same side of the vehicle. In some embodiments, a suspension system can be coupled to a front wheel on one side of the vehicle and to a rear wheel on the opposite side of the vehicle.

In one aspect, a vehicle can include multiple suspension systems, such as a suspension system for the front of the vehicle and a suspension system for the rear of the vehicle, or a suspension system for the driver side of the vehicle and a suspension system for the passenger side of the vehicle. In multiple suspension system configurations, two or more suspension systems can be coupled to a common control system 140, with one or more sensors 141, 142 associated with each suspension system to sense vehicle dynamics related to each suspension system. Alternatively, each suspension system can operate with its own control system. The wheels coupled to a suspension system as disclosed herein can be drive wheels, steer wheels, and/or trailer wheels (i.e., neither drive nor steer wheels). The wheels of the vehicle 100 as illustrated are arranged in a typical wheel configuration, where two wheels are located on or along each of the sides of the vehicle in an opposing manner, as shown (e.g., left/right or driver/passenger sides). Typically, front wheels in this configuration are steer wheels. Such vehicles may be front-wheel drive, rear-wheel drive, or all-wheel drive.

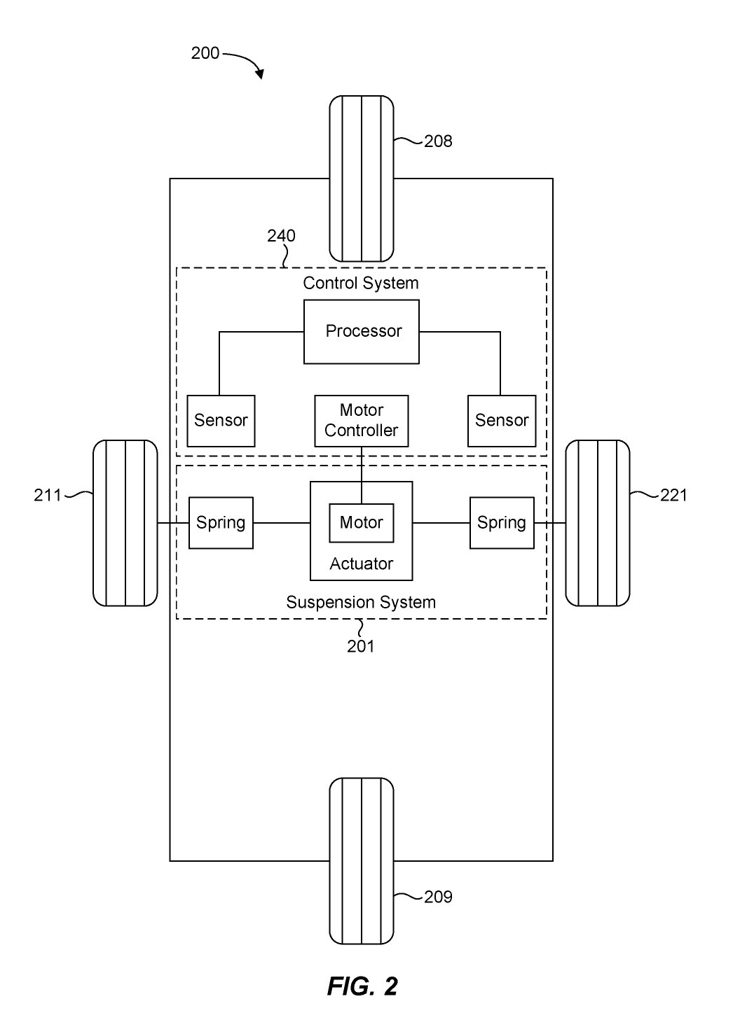

A suspension system and a control system as disclosed herein can be incorporated in a vehicle with any suitable wheel configuration. For example, FIG. 2 shows a suspension system 201 and a control system 240 in a vehicle 200, which has a diamond wheel pattern. In this wheel configuration, side wheels 211, 221 are located on opposite sides of the vehicle 200, roughly midway between the front and rear of the vehicle 200. A front wheel 208 is located at the front of the vehicle 200 on a longitudinal centerline of the vehicle 200, and a rear wheel 209 is located at the rear of the vehicle 200 on the longitudinal centerline of the vehicle 200. The side wheels 211, 221 may be drive wheels, while the front and rear wheels 208, 209 may be steer wheels.

Referring again to FIG. 1, the springs 110, 120 can be any suitable type of spring, such as a mechanical spring (i.e., a spring made of a resiliently flexible material) and/or a pneumatic spring (i.e., a gas, such as air or nitrogen). Each of the springs 110, 120 can have a spring characteristic, such as a spring rate and/or preload, which can affect or define performance or behavior of the springs. The actuator 130 can be coupled to the springs 110, 120 such that actuation of the actuator 130 causes a change in the spring characteristics of the springs 110, 120. In particular, the change in the spring characteristic of the spring 110 can be inversely proportional to the change in the spring characteristic of the spring 120 to adjust vehicle handling. This is explained in further detail below.

The control system 140 can work in conjunction with the suspension system 101 to form a feedback control loop. For example, the control system 140 can be configured to monitor a dynamic vehicle property and control actuation of the actuator 130 to adjust vehicle handling in response to the dynamic vehicle property. The dynamic vehicle property can be any property or characteristic that may change during operation of the vehicle 100 and that represents an aspect of vehicle handling or performance, such as fore/aft acceleration, lateral acceleration, the direction of gravity relative to the vehicle, vehicle ride height, and/or suspension movement. The one or more sensors 141, 142 can be configured to sense the dynamic vehicle property. The sensors 141, 142 can be any suitable type of sensor, such as an accelerometer, a gravity sensor, a position sensor (e.g., measure linear or rotational position), a distance sensor and/or others as known in the art. The control system 140 can also include a processor 143 that receives data from the sensors 141, 142 and provides an actuator command 144 to control actuation of the actuator 130, such as a speed and direction of the actuator 130. In one aspect, the actuator 130 can comprise a motor 131 and the control system 140 can include an actuator controller 145 that receives the actuator command 144 and outputs a control signal 146 to the actuator 130. The actuator controller 145 (in this example the motor controller) can therefore interpret the actuator command 144 and translate the actuator command 144 into a form that is compatible with the actuator 130 and provided as the control signal 146. The actuator controller 145 can be any suitable device that can enable computer (i.e., digital) control of an analog device. For example, the actuator command 144 may be in a digital format. The actuator controller 145 can include a digital to analog converter (DAC) that can be used to convert the digital actuator command 144 to an analog control signal 146 configured to control the motor 131. Thus, speed and direction data of the actuator command 144 can be converted into a format that is configured to operate the motor 131. In one aspect, the control signal can provide a voltage and/or a current configured to control the motor 131 (e.g., an electric motor). In another aspect, the control signal 146 can be configured to provide servo control of one or more servo motors that may be associated with the motor 131 (e.g., to control a throttle and/or engagement with a forward or reverse gear associated with the motor 131).

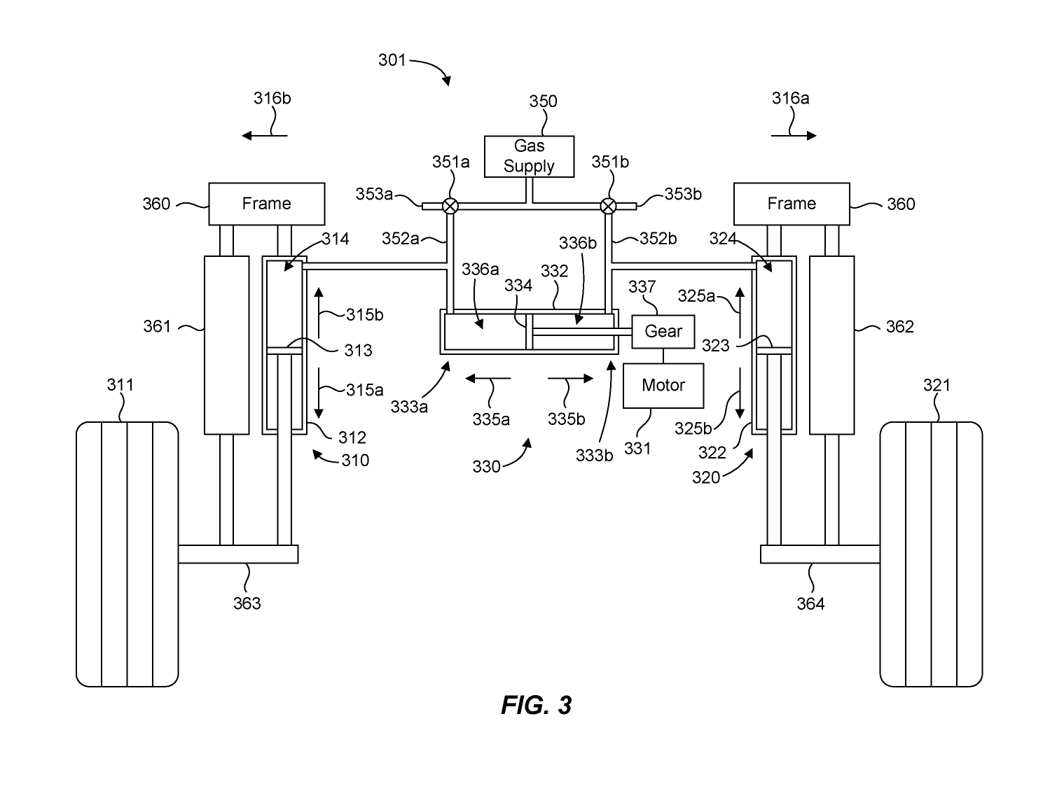

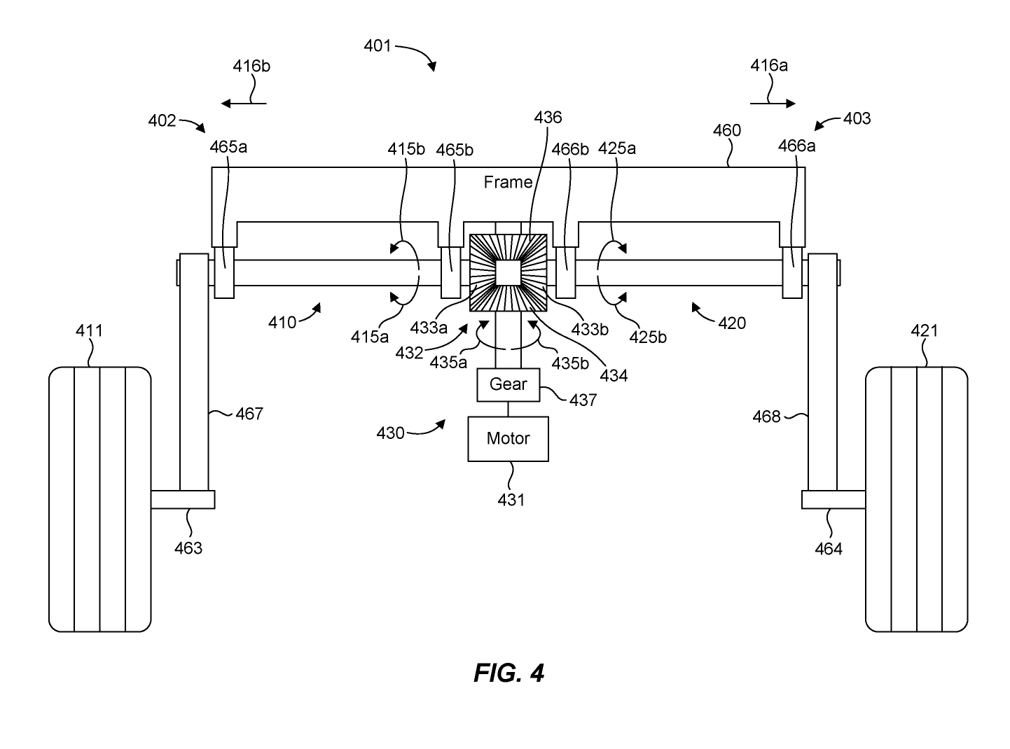

In one embodiment, the sensors 141, 142 can be configured to sense and determine vehicle lateral lean in corners (e.g., body roll) and/or fore/aft rearward squat under acceleration and forward pitch under braking. In one aspect, the sensors 141, 142 can be configured to measure ride height of the vehicle at each wheel associated with a suspension system as disclosed herein, such as with a position sensor and/or a distance sensor. In another aspect, the lateral lean, rearward squat, and forward pitch can be determined utilizing one or more accelerometers and/or gravity sensors. The processor 143 can receive data from the sensors 141, 142 to determine how to adjust the suspension system 140 as the vehicle 100 is driven. For example, during cornering, the vehicle 100 will tend to lean to the outside of the corner, which can cause a shift in the center of mass that can cause the vehicle to become unstable. When this happens, the ride height of the vehicle 100 at the outside of the corner will tend to decrease, while the ride height of the vehicle at the inside of the corner will tend to increase. In response to input from the sensors 141, 142, the processor 143 can determine how to adjust the suspension system 101 to behave in a manner that causes the vehicle 100 to become or remain level, or even to “lean” into a corner, meaning that center of mass will be caused to shift in the opposite direction with the ride height of the vehicle at the outside of the corner will increase, while the ride height of the vehicle at the inside of the corner will decrease. A similar dynamic can occur during acceleration or braking, which tends to cause the vehicle 100 to squat rearward or to pitch forward. The manner in which the suspension system 101 can be adjusted is discussed with reference to the examples shown in FIGS. 3 and 4.

FIG. 3 illustrates an end schematic view of a vehicle suspension system 301 in accordance with an example of the present disclosure. Although the suspension system 301 is shown and described in the context of two wheels 311, 321 on opposite lateral sides of a vehicle, it should be recognized that the suspension system can be applied to wheels located on the same side of a vehicle, or to a front wheel on one side and a rear wheel on an opposite side of a vehicle.

As described generally above, the suspension system 301 can include springs 310, 320 coupled to the wheels 311, 321, and an actuator 330 coupled to the springs 310, 320 such that actuation of the actuator 330 causes a change in the spring characteristics of the springs 310, 320. In particular, the change in the spring characteristic of the spring 310 can be inversely proportional to the change in the spring characteristic of the spring 320 to adjust vehicle handling.

In this example, the suspension system 301 is a pneumatic system where the springs 310, 320 are gas charged springs (e.g., with air or nitrogen). The gas charged springs 310, 320 are shown as having cylinders 312, 322 and pistons 313, 323 that are movable within the cylinders 312, 322, respectively. The pistons 313, 323 partially define gas chambers 314, 324 within the respective cylinders 312, 322. The springs 310, 320 can be coupled to a vehicle frame or chassis 360 and to the wheels 311, 321 via axles 363, 364 or other suitable suspension components (e.g., swing arms). Although the gas springs are shown and described as having cylinders and pistons, it should be recognized that the gas springs can have any suitable configuration, such as gas bladders or bags (e.g., made of rubber or other such flexible material).

The suspension system 301 can include any suitable suspension component, such as dampers 361, 362, which can be coupled to the vehicle frame or chassis 360 and to the wheels 311, 321 in parallel with the respective springs 310, 320.

The actuator 330 can include a cylinder 332 with an end 333a in fluid communication with the gas charged spring 310, and an end 333b in fluid communication with the gas charged spring 320. The actuator 330 can also include a double acting piston 334 disposed in the cylinder 332. The piston 334 can be configured to move within the cylinder 332 (i.e., between the ends 333a, 333b) in directions 335a, 335b. The piston 334 can partially define gas chambers 336a, 336b within the cylinder 332 on opposite side of the piston 334. The actuator 330 can include a motor 331 to drive the piston 334. The position of the piston 334 can be determined by the input to the motor 331 as controlled by the control system. The motor 331 can be any suitable type of motor, such as an electric motor, a hydraulic motor, an internal combustion motor, etc. In some embodiments, the motor 331 can be coupled to the piston 334 by a gear 337. In one aspect, the gear 337 can be a reduction gear. In another aspect, the gear 337 can be configured to convert rotational motion from a drive shaft of the motor to linear motion of the piston 334. Operation of the actuator 330 (i.e., the motor 331) can be controlled by a control system as described above.

The piston 334 can separate the gas between the gas springs 310, 320. Thus, movement of the piston 334 can change gas pressures of the gas charged springs 310, 320 thereby changing the spring characteristics (e.g., spring rate and/or preload) of the springs 310, 320. For example, changing the gas pressure of the springs 310, 320 can change the spring rate and the preload proportional to the gas pressure. In particular, movement of the piston 334 in the direction 335a reduces the gas volume in the spring 310, which increases the gas pressure in the chamber 314 of the spring 310 and therefore increases the spring rate and the preload of the spring 310. This tends to move the piston 313 of the spring 310 in direction 315a. Simultaneously, the movement of the piston 334 in the direction 335a increases the gas volume in the spring 320, which decreases the gas pressure in the chamber 324 of the spring 320 and therefore decreases the spring rate and the preload of the spring 320. This tends to move the piston 323 of the spring 320 in direction 325a. The combined effect is a tendency of the vehicle to lean in direction 316a. Thus, in an example operation, if the vehicle is turning in a direction 316a, the suspension system can be controlled to cause the vehicle to lean also in the direction 316a, thus leaning “into” the turn.

On the other hand, movement of the piston 334 in the direction 335b reduces the gas volume in the spring 320, which increases the gas pressure in the chamber 324 of the spring 320 and therefore increases the spring rate and the preload of the spring 320. This tends to move the piston 323 of the spring 320 in direction 325b. At the same time, the movement of the piston 334 in the direction 335b increases the gas volume in the spring 310, which decreases the gas pressure in the chamber 314 of the spring 310 and therefore decreases the spring rate and the preload of the spring 310. This tends to move the piston 313 of the spring 310 in direction 315b. The combined effect is a tendency of the vehicle to lean in direction 316b. Thus, in an example operation, if the vehicle is turning in a direction 316b, the suspension system can be controlled to cause the vehicle to lean also in the direction 316b, thus leaning “into” the turn.

The performance or spring characteristics of the springs 310, 320 are thus tied to one another in an inverse relationship by the actuator 330 to adjust vehicle handling. The characteristics of the gas springs 310, 320 can be inversely adjusted at any given time to suit different driving conditions by moving or actuating the piston 334, thus changing the gas pressures of the springs 310, 320. This can be useful for high load variation in cornering, acceleration, and/or braking. Because the springs 310, 320 each have separate gas volumes (as separated by the piston 334), the springs 310, 320 act independent of one another in response to loading conditions. In other words, the springs 310, 320 act as typical independent springs in response to external loads. It is the spring characteristics (i.e., spring rate and preload) of the springs 310, 320 that are inversely related to one another and which are changed by the movement of the piston 334 (i.e., actuation of the actuator 330). In one aspect, the spring characteristics can be inversely adjusted as described above to accommodate an uneven distribution of payload weight on one wheel compared to the other wheel, which would tend to cause a tipping of the vehicle to one side. Thus, spring characteristics can be adjusted to accommodate static loading as well as dynamic loading of a vehicle. In some embodiments, gas pressure sensors can be included as part of a control system to provide additional data for controlling the actuator 330 to adjust vehicle handling.

In one aspect, the suspension system 301 can include a gas supply 350 (e.g., a reservoir and/or a compressor), which can serve to increase gas pressure in the gas springs 310, 320. Valves 351a, 351b can be included in gas supply lines 352a, 352b to allow the gas pressures in the springs 310, 320 to be adjusted individually. Outlets 353a, 353b can also be included to reduce gas pressure in the springs 310, 320. The illustrated configuration of the gas supply lines 352a, 352b, the valves 351a, 351b, and the outlets 353a, 353b is such that the valves 351a, 351b are three-way valves. It should be recognized, however, that any suitable configuration of gas supply lines, valves (e.g., two-way and/or three-way valves), and outlets may be utilized. The valves 351a, 351b can be controlled by the control system, which can control the suspension system as described above.

The gas supply 350, valves 351a, 351b and associated supply lines and outlet structures 353a, 353b can be used independently or in cooperation with the actuator 330 in statically or dynamically adjusting spring characteristics of the springs 310, 320. For example, gas pressure can be increased or decreased in both springs 310, 320 to accommodate a given payload and/or a change in ambient temperature and maintain a desired nominal ride height. On the other hand, uneven gas pressures may be provided for each spring 310, 320 to accommodate an uneven payload distribution with the piston 334 of the actuator 330 in a center position within the chamber 332. Desired driving characteristics can therefore be maintained with or without additional loads on the vehicle, such as those due to acceleration forces that occur when operating the vehicle, or applied static loads.

In one aspect, the suspension system 301 can function as a closed system, where gas is not added to or subtracted from the gas springs 310, 320 while the vehicle is in operation. Instead of adding or removing gas from the springs to achieve a desired spring characteristic, all the gas that is needed to operate the suspension system 301 is contained in the closed system, with gas pressure varied in the gas springs 310, 320 by the movement of the piston 334. Thus, once the control system adjusts the gas pressure for proper load support by the gas springs 310, 320, the actuator 330 can modulate the gas pressure between the springs, with no introduction of gas during operation of the vehicle.

FIG. 4 illustrates a top schematic view of a vehicle suspension system 401 in accordance with another example of the present disclosure. Although the suspension system 401 is shown and described in the context of two wheels 411, 421 on opposite lateral sides of a vehicle, it should be recognized that the suspension system can be applied to wheels located on the same side of a vehicle, or to a front wheel on one side and a rear wheel on an opposite side of a vehicle.

As described generally above, the suspension system 401 can include springs 410, 420 coupled to the wheels 411, 421, and an actuator 430 coupled to the springs 410, 420 such that actuation of the actuator 430 causes a change in the spring characteristics of the springs 410, 420. In particular, the change in the spring characteristic of the spring 410 can be inversely proportional to the change in the spring characteristic of the spring 420 to adjust vehicle handling.

In this example, the suspension system 401 is a mechanical system where the springs 410, 420 are configured as torsion springs. The torsion springs 410, 420 are shown as having shaft or bar configurations, which can be solid or tubular. The springs 410, 420 can be coupled to a vehicle frame or chassis 460 via bearings or bushings 465a-b, 466a-b, respectively. The suspension system 401 can include any suitable suspension component, such as dampers (not shown), which can be coupled to the vehicle frame or chassis 460 and to the wheels 411, 421.

The actuator 430 can include a gear train 432 with an output 433a coupled to the torsion spring 410, and an output 433b coupled to the torsion spring 420. The outputs 433a, 433b can be configured to rotate in opposite directions. For example, the gear train 432 can include a drive gear 434, a gear coupled to the drive gear 434 providing the output 433a, and a gear coupled to the drive gear 434 providing the output 433b. In one aspect, the drive gear 434, the output gear 433a, and the output gear 433b can be configured as bevel gears. Rotation of the drive gear 434 in direction 435a can cause the output gear 433a to rotate in direction 415a and the output gear 433b to rotate in direction 425a. The directions 415a and 425a are opposite one another. Similarly, rotation of the drive gear 434 in direction 435b can cause the output gear 433a to rotate in direction 415b and the output gear 433b to rotate in direction 425b. The directions 415b and 425b are opposite one another. The gear train 432 can also include an idler gear 436 that can be supported by the frame 460 to maintain the output gears 433a, 433b in contact with the drive gear 434 under high load.

Torque arms 467, 468 can be coupled to the torsion springs 410, 420, respectively. The torque arms 467, 468 can be coupled to the wheels 411, 421 via axles 463, 464, respectively, or other suitable suspension components. In one aspect, the torque arms 467, 468 can form or serve as swing arms for the suspension system 401. The torque arms 467, 468 can be coupled to the torsion springs 410, 420 with the torsion springs 410, 420 disposed between the respective outputs 433a, 433b and the torque arms 467, 468. Thus, as the wheels 411, 421 move vertically (i.e., in and out of the page), the torsion springs 410, 420 can twists along their length providing a spring for the vehicle.

The actuator 430 can include a motor 431 to drive the drive gear 434. The rotary position of the drive gear 434 can be determined by the input to the motor 431. The motor 431 can be any suitable type of motor, such as an electric motor, a hydraulic motor, an internal combustion motor, etc. In some embodiments, the motor 431 can be coupled to the drive gear 434 by a gear 437, which can be a reduction gear. Operation of the actuator 430 (i.e., the motor 431) can be controlled by a control system as described above.

Rotation of the actuator outputs 433a, 433b in opposite directions, as described above, can thereby change a spring characteristic (e.g., preload) of the springs 410, 420. In particular, rotation of the drive gear 434 in the direction 435a causes the spring 410, which is coupled to the output 433a, to rotate in direction 415a and therefore increases the preload of the spring 410. This tends to raise the side 402 of the vehicle (i.e., move out of the page). Simultaneously, rotation of the drive gear 434 in the direction 435a causes the spring 420, which is coupled to the output 433b, to rotate in direction 425a and therefore decreases the preload of the spring 420. This tends to lower the side 403 of the vehicle (i.e., move into of the page). The combined effect is a tendency of the vehicle to lean in direction 416a.

On the other hand, rotation of the drive gear 434 in the direction 435b causes the spring 410, which is coupled to the output 433a, to rotate in direction 415b and therefore decreases the preload of the spring 410. This tends to lower the side 402 of the vehicle (i.e., move into of the page). At the same time, rotation of the drive gear 434 in the direction 435b causes the spring 420, which is coupled to the output 433b, to rotate in direction 425b and therefore increases the preload of the spring 420. This tends to raise the side 403 of the vehicle (i.e., move out of the page). The combined effect is a tendency of the vehicle to lean in direction 416b.

The performance or spring characteristics of the springs 410, 420 are thus tied to one another in an inverse relationship by the actuator 430 to adjust vehicle handling. The characteristics of the torsion springs 410, 420 can be inversely adjusted at any given time to suit different driving conditions by rotating or actuating the drive gear 434, thus changing the preload of the springs 410, 420. This can be useful for high load variation in cornering, acceleration, and/or braking. Because the springs 410, 420 are separate springs (as separated by the gear train 432), the springs 410, 420 act independent of one another in response to loading conditions. In other words, the springs 410, 420 act as typical independent springs in response to external loads. It is the spring characteristics (i.e., the preload) of the springs 410, 420 that are inversely related to one another and which are changed by the movement of the drive gear 434 (i.e., actuation of the actuator 430). In one aspect, the spring characteristics can be inversely adjusted as described above to accommodate an uneven distribution of payload weight on one wheel compared to the other wheel, which would tend to cause a tipping of the vehicle to one side. Thus, spring characteristics can be adjusted to accommodate static loading as well as dynamic loading of a vehicle. In some embodiments, strain gage sensors can be included on the springs 410, 420 as part of a control system to provide data for controlling the actuator 430 to adjust vehicle handling.

In accordance with one embodiment of the present invention, a method of facilitating adjustment of a vehicle suspension system is disclosed. The method can comprise providing a vehicle suspension system including a first spring having a first spring characteristic, and a second spring having a second spring characteristic. Additionally, the method can comprise facilitating a change in the first and second spring characteristics, wherein the change in the second spring characteristic is inversely proportional to the change in the first spring characteristic to adjust vehicle handling. It is noted that no specific order is required in this method, though generally in one embodiment, these method steps can be carried out sequentially.

In one aspect of the method, facilitating a change in the first and second spring characteristics can comprise providing an actuator coupled to the first and second springs. In one aspect, the method can further comprise providing at least one of a gas inlet and a gas outlet associated with each of the first and second gas charged springs to vary the gas pressures. In another aspect, the method can further comprise providing a first torque arm coupled to the first torsion spring with the first torsion spring disposed between the first output and the first torque arm, and a second torque arm coupled to the second torsion spring with the second torsion spring disposed between the second output and the second torque arm, wherein the first and second torque arms are configured to couple to wheels of a vehicle.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A vehicle suspension system, comprising:
a first spring having a first spring characteristic;
a second spring having a second spring characteristic; and
an actuator coupled to the first and second springs, whereby actuation of the actuator causes a change in the first and second spring characteristics, wherein the change in the second spring characteristic is inversely proportional to the change in the first spring characteristic to adjust vehicle handling.

2. The vehicle suspension system of claim 1, wherein the first and second spring characteristics comprise at least one of preload and spring rate.

3. The vehicle suspension system of claim 1, wherein the first and second springs each comprise a gas charged spring.

4. The vehicle suspension system of claim 3, wherein the actuator comprises:
a cylinder having a first end in fluid communication with the first gas charged spring, and a second end in fluid communication with the second gas charged spring; and
a double acting piston disposed in the cylinder and configured to move between the first and second ends, wherein movement of the piston changes gas pressures of the first and second gas charged springs thereby changing the first and second spring characteristics.

5. The vehicle suspension system of claim 4, wherein the actuator comprises a motor to drive the piston.

6. The vehicle suspension system of claim 4, further comprising at least one of a gas inlet and a gas outlet associated with each of the first and second gas charged springs to vary the gas pressures.

7. The vehicle suspension system of claim 1, wherein the first and second springs are each configured as a torsion spring.

8. The vehicle suspension system of claim 7, wherein the actuator comprises a gear train having a first output coupled to the first torsion spring and a second output coupled to the second torsion spring, where the first and second outputs are configured to rotate in opposite directions thereby changing the first and second spring characteristics.

9. The vehicle suspension system of claim 8, further comprising a first torque arm coupled to the first torsion spring with the first torsion spring disposed between the first output and the first torque arm, and a second torque arm coupled to the second torsion spring with the second torsion spring disposed between the second output and the second torque arm, wherein the first and second torque arms are configured to couple to wheels of a vehicle.

10. The vehicle suspension system of claim 9, wherein the first and second torsion springs comprise shaft configurations.

11. The vehicle suspension system of claim 8, wherein the gear train comprises:
a drive gear;
a first gear coupled to the drive gear providing the first output; and
a second gear coupled to the drive gear providing the second output.

12. The vehicle suspension system of claim 11, wherein the drive gear, the first gear, and the second gear are configured as bevel gears.

13. The vehicle suspension system of claim 8, wherein the actuator comprises a motor to drive the gear train.

14. A vehicle, comprising:
a first wheel;
a second wheel; and
a suspension system including
a first spring coupled to the first wheel and having a first spring characteristic,
a second spring coupled to the second wheel and having a second spring characteristic, and
an actuator coupled to the first and second springs such that actuation of the actuator causes a change in the first and second spring characteristics, wherein the change in the second spring characteristic is inversely proportional to the change in the first spring characteristic to adjust vehicle handling.

15. The vehicle of claim 14, wherein the first and second spring characteristics comprise at least one of preload and spring rate.

16. The vehicle of claim 14, wherein the first and second springs each comprise a gas charged spring.

17. The vehicle of claim 16, wherein the actuator comprises:
a cylinder having a first end in fluid communication with the first gas charged spring, and a second end in fluid communication with the second gas charged spring; and
a double acting piston disposed in the cylinder and configured to move between the first and second ends, wherein movement of the piston changes gas pressures of the first and second gas charged springs thereby changing the first and second spring characteristics.

18. The vehicle of claim 17, wherein the actuator comprises a motor to drive the piston.

19. The vehicle of claim 17, further comprising at least one of a gas inlet and a gas outlet associated with each of the first and second gas charged springs to vary the gas pressures.

20. The vehicle of claim 14, wherein the first and second springs are each configured as a torsion spring.

21. The vehicle of claim 20, wherein the actuator comprises a gear train having a first output coupled to the first torsion spring and a second output coupled to the second torsion spring, where the first and second outputs are configured to rotate in opposite directions thereby changing the first and second spring characteristics.

22. The vehicle of claim 21, further comprising a first torque arm coupled to the first torsion spring with the first torsion spring disposed between the first output and the first torque arm, and a second torque arm coupled to the second torsion spring with the second torsion spring disposed between the second output and the second torque arm, wherein the first and second torque arms are configured to couple to wheels of a vehicle.

23. The vehicle of claim 22, wherein the first and second torsion springs comprise shaft configurations.

24. The vehicle of claim 21, wherein the gear train comprises:
a drive gear;
a first gear coupled to the drive gear providing the first output; and
a second gear coupled to the drive gear providing the second output.

25. The vehicle of claim 24, wherein the drive gear, the first gear, and the second gear are configured as bevel gears.

26. The vehicle of claim 21, wherein the actuator comprises a motor to drive the gear train.

27. The vehicle of claim 14, wherein the first wheel is on a left side of the vehicle and the second wheel is on a right side of the vehicle.

28. The vehicle of claim 14, wherein the first wheel is a front wheel of the vehicle and the second wheel is a back wheel of the vehicle.

29. The vehicle of claim 14, further comprising a control system to monitor a dynamic vehicle property and control actuation of the actuator to adjust vehicle handling in response to the dynamic vehicle property.

30. The vehicle of claim 29, wherein the dynamic vehicle property comprises at least one of fore/aft acceleration, lateral acceleration, ride height, and suspension movement.

31. The vehicle of claim 29, wherein the control system comprises:
a sensor to sense the dynamic vehicle property; and
a processor that receives data from the sensor and provides an actuator command to control actuation of the actuator.

32. The vehicle of claim 31, wherein the sensor comprises at least one of an accelerometer, a gravity sensor, a position sensor, and a distance sensor.

33. The vehicle of claim 31, wherein the control system further comprises an actuator controller that receives the actuator command and outputs a control signal to the actuator.

34. A method of facilitating adjustment of a vehicle suspension system, comprising:
providing a vehicle suspension system including
a first spring having a first spring characteristic, and
a second spring having a second spring characteristic; and
facilitating a change in the first and second spring characteristics, wherein the change in the second spring characteristic is inversely proportional to the change in the first spring characteristic to adjust vehicle handling.

35. The method of claim 34, wherein the first and second spring characteristics comprise at least one of preload and spring rate.

36. The method of claim 34, wherein facilitating a change in the first and second spring characteristics comprises providing an actuator coupled to the first and second springs.
